(19) United States
(12) Patent Application Publication
(10) Pub. No.: US 2010/0223623 A1
(43) Pub. Date: Sep. 2, 2010

(54) METHODS AND SYSTEMS FOR WORKFLOW MANAGEMENT

(76) Inventors: Jodi Strong, Los Angeles, CA (US); Joseph A. Craig, Anaheim, CA (US); Kelly Kinnett, Redondo Beach, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 12/395,380

(22) Filed: Feb. 27, 2009

(51) Int. Cl. G06F 9/50

(52) U.S. Cl. 718/105

(57) ABSTRACT

Systems and method are described for workflow management, and in particular, for workflow management with respect to filming. In response to a filming permit request, a workflow computer system examines workloads associated with permit coordinators. Optionally, the examination takes into account coordinator performance in attempting to balance workloads. The permit request is routed to a selected permit coordinator who is tasked with resolving permit issues. In addition, the permit request is routed to approving entities associated with the permit workflow. Optionally, conflicts with other permits are identified. Substantially real-time workflow status updates are provided to the requester and/or coordinator. The workflow computer system automatically identifies to the coordinator deficiencies associated with the permit that are to be resolved.

### COPYRIGHT RIGHTS

A portion of the disclosure of this patent document contains material that is subject to copyright protection. The copyright owner has no objection to the facsimile reproduction by any one of the patent document or the patent disclosure, as it appears in the Patent and Trademark Office patent file or records, but otherwise reserves all copyright rights whatsoever.

### STATEMENT REGARDING FEDERALLY SPONSORED R&D

Not applicable.

### PARTIES OF JOINT RESEARCH AGREEMENT

Not applicable.

### REFERENCE TO SEQUENCE LISTING, TABLE, OR COMPUTER PROGRAM LISTING

Not applicable.

### BACKGROUND OF THE INVENTION

1. Field of the Invention

The present invention relates to methods and systems for managing workflow, and in particular, to methods and systems for managing inter-enterprise workflow.

2. Description of the Related Art

Computer-based systems exist for coordinating and managing workflow. A workflow is a series of steps or activities needed to complete a task. Typically, many conventional workflow systems are used to coordinate and manage tasks within a single enterprise and do not adequately manage workflow with respect to tasks performed across multiple enterprise.

Further, many conventional workflow systems lack artificial intelligence and therefore cannot adequately handle exception conditions.

### SUMMARY OF THE INVENTION

Methods and systems are described for managing workflow, such as the workflow associated with the film permit process.

In certain embodiments, a system manages a permit workflow that includes the following work performers: an applicant, a coordinator (or other administrator), and one or more approving entities/agencies. Certain embodiments perform conflict detection when multiple applicants attempt to reserve the same resources, such as the same filming location.

Optionally, in response to a filming permit request (e.g., for filming and/or taking photographs at a specified location), a first computer system examines workloads associated with permit coordinators. Optionally, the examination takes into account coordinator performance and/or experience in attempting to balance workloads. The permit request is routed to a selected permit coordinator whose task is to resolve issues. In addition, the permit request is routed to approving entities. Substantially real-time workflow status updates are provided to the requester and coordinator. The computer system automatically identifies to the coordinator deficiencies associated with the permit.

An example embodiment provides a computer-implemented method for managing workflow, the method comprising: receiving at a first computer system, the first computer system including one or more processors, a filming permit request from a requester, the request including insurance policy information and a filming location reservation request, wherein the filming location reservation request specifies a first location, a date, and a time period; examining, using the first computer system, workloads of a plurality of coordinators; at least partly based on the workload examination, assigning the permit request to a first coordinator so as to enhance workload balance; determining, using the first computer system, if the insurance policy associated with the insurance policy information has a deficiency, wherein the deficiency relates to expiration of the insurance policy and/or to insufficient policy limits; determining, using the first computer system, whether a conflict exists with respect to the filming location reservation request by determining whether another filming location reservation request exists within a first area during a first time period, wherein the first area includes an area surrounding at least a portion of the first location; automatically transmitting a notification to the requester and to the first coordinator if there is an insurance policy deficiency and/or a location conflict, wherein the notification provides an indication to the first coordinator that the one or more permit request issues need to be resolved; routing via a network the filming permit request to one or more approving entities associated with the workflow whose tasks include approving or disapproving the permit request; receiving at the first computer system an approval or a disapproval of the filming permit request from the one or more approving entities associated with the workflow; providing, via the first computer system substantially, real-time status information regarding permit request approval updates from the one or more approving entities to the first coordinator and to the requester; determining if the one or more approving entities have provided approval indications; and based at lest in part on: the determination as to whether one or more approving entities have provided approval indications; the determination as to whether the insurance policy has a deficiency; and/or the conflict determination; indicating whether an approved film permit is to be issued to the requester.

An example embodiment provide a computer-readable storage media containing instructions that, when executed are configured to: examine data associated with a filming permit request, the permit request including a reservation request for filming at a first location, on a first date, at a first time period; examine workloads associated with a plurality of film permit coordinators; access indicators as to performance and/or experience associated with the film permit coordinator; based at least in part on the workload examination and the performance and/or experience indicators, assign the workflow permit to a first permit coordinator; automatically identify one or more deficiencies related to the permit request to the first permit coordinator; determine whether a conflict exists with respect to the filming location reservation request by determining whether another filming location reservation request exists within a first area during a first time period, wherein the first area includes an area surrounding at least a portion of the first location; route the permit request to one or more approval entities; record approvals from the one or more approval entities in computer readable memory; provide approval status to the first permit coordinator; based at least in part on: the determination as to whether one or more approving entities have provided approval indications; the determination as to whether the permit request has a deficiency; and/or the conflict determination; provide an indication related to whether an approved film permit is to be issued to the requester.

An example embodiment provides a computer-implemented method for managing workflow, the method comprising: receiving at a first computer system, the first computer system including one or more processors, a filming permit request from a requester, the request including a filming location reservation request, wherein the filming location reservation request specifies a first location, a date, and a time period; examining, using the first computer system, workloads of a plurality of coordinators; at least partly based on the workload examination, assigning the permit request to a first coordinator; determining, using the first computer system, whether a conflict exists with respect to the filming location reservation request by determining whether another filming location reservation request exists within a first area during a first time period, wherein the first area includes an area adjacent to at least a portion of the first location; automatically transmitting a notification to the requester and/or to the first coordinator if there is a location conflict; routing via a network the filming permit request to one or more approving entities associated with the workflow whose tasks include approving or disapproving the permit request; receiving at the first computer system an approval or a disapproval of the filming permit request from the one or more approving entities associated with the workflow; providing, via the first computer system, substantially real-time status information regarding permit request approval updates from the one or more approving entities to the first coordinator and to the requester; determining if the one or more approving entities have provided approval indications; and providing an indication related to whether an approved film permit is to be issued to the requester.

### BRIEF DESCRIPTION OF THE DRAWINGS

Specific embodiments will now be described with reference to the drawings, which are intended to illustrate and not limit various features of the inventions. These embodiments may be combined, other embodiments may be utilized, and structural changes may be made without departing from the spirit or scope of the present invention.

FIG. 1 illustrates an exemplary computing system operating environment.

FIG. 2 illustrates an example work flow process.

FIG. 3 illustrates an example conflict identification and resolution process.

FIGS. 4-11 illustrate example user interfaces.

FIGS. 12A-C illustrate an example permit.

### DETAILED DESCRIPTION OF PREFERRED EMBODIMENTS

Example embodiments herein provide for workflow management with respect to coordinating filming activities (e.g., movie filming, still photography, etc.) and the permitting process.

An example embodiment facilitates planning, communication and data transfer between multiple entity types, such as a permitting agency, permitting agency clients (e.g., city agencies, such as police, fire departments, etc., whose approval is needed as part of the permit approval process), permitting agency customers (those seeking permits), and other entities (such as private citizens or businesses) who are to be notified regarding filming in their geographical area.

Further, example embodiments provide for the generation of permits, the assignment of personnel to monitor the locations on a permit, the collection of fees associated with the filming activity, and the routing of permit applications to one or more agencies for approval. Further, example embodiments provide communications techniques, such as e-mails, requests, notes, and comments, to enable groups to effectively communicate and coordinate with each other.

Certain example embodiments enable a permit applicant to create and save permit application templates for future permit applications via corresponding user interfaces (e.g., via web pages served by the workflow system over a network) provided for display on a user terminal. This enables a reduction in repetitive data entry when generating permit applications.

By way of example, a permit may specify some or all of the following: location, date, time, shooting category (e.g., motion, still, movie, commercial, television show, etc.), contact information, insurance information, size of cast and crew, filming activities and equipment used, requested lane or road closures, number of trucks, power/water service requests, special filming conditions, etc.

When a permit request (e.g., in the form of a permit application) is received at the permit workflow system, the permit application information is stored in computer readable memory. The permitting workflow system optionally transmits to the permit applicant substantially instant confirmation that the permit application was received. For example, the confirmation can be transmitted to the applicant's terminal via a web page notification, an email, an instant message, or otherwise. The workflow system enables applicants to modify the permit application after it has been submitted to the permitting agency. Further, certain embodiments automatically validate a permit applicant's insurance policy for the applicant's filming.

Certain embodiments of the permit workflow system provide substantially real-time status updates to the applicant regarding the permit application processing progress and the status of agency approvals (e.g., approval by particular agencies and/or approval of particular requests, such as approval of road closures, provision of police, emergency medical service personnel, monitors, and/or fire department personnel, city provision of electricity, water, etc., although the status of agency approval may be provided for fewer, additional, and/or different agencies). If a problem with the permit approval process occurs, which may be a problem relating to the requested location or timing of the filming or may relate to applicant data, the applicant can be substantially immediately notified so that the applicant can, where appropriate, address the problem (e.g., select another location and/or time, provide updated insurance information, take care of a past due account balance, etc.). This enables problems to be identified (by the system and/or a human) and rectified quickly, to thereby enable appropriate conforming permits to be promptly approved and issued. Examples of the types of permitting problems that may arise can include, but are not limited to:
the filming location is already being used by another applicant at the requested time;
a nearby location is already being used by another applicant at the requested time (e.g., where the nearby location is in within a specified distance of the requested filming location);
the location will be unavailable because of maintenance work;
the applicant's insurance has expired;
the applicant has a past due balance (e.g., with respect to permit fees);
etc.

Similarly, the system can automatically detect certain issues (e.g., a time/location conflict, insurance problems, account problem, etc.), and notify an appropriate permit process administrator (e.g., via email, SMS message, instant message, web page message, or otherwise), who can take appropriate action to resolve the issue.

With respect to fees, a permit is typically associated with fees. The fees may include a static amount (e.g., a fixed fee for the permit) and a dynamic portion (e.g., to cover the hourly, per person cost of police, EMS, monitors, fire department, and/or other entity presence at the filming location). Certain embodiments generate an estimate for the dynamic portions and total the static amount and the estimated portion to generate a total amount. The total amount can be presented to the applicant, and the applicant can then be billed for that amount.

For example, the estimate fee may be generated based on the permit request information (e.g., request or need for fire department, police department, and/or other government personnel need to be present, request for water or electricity services from department of water and power, an indication that damage may be done to the location, etc.), and on historical data for location shoots having one or more similar characteristics to that associated with the permit request.

Certain embodiments optionally include an accounting module to assist in the tracking and collection of fees associated with each permit. For example, the accounting module can compare estimated fees for permits with actual or final permit fees (which may differ from the estimated fees based on the actual length of the shoot, damage done during the shoot, and city services used during the shoot, etc.). The account module can then bill or remit the difference to the applicant, and route any additional appropriate fees to the designated recipient (e.g., to a city agency based on services provided).

Optionally, the permit workflow system include an administrative module that enables the permitting agency to add, modify or delete fees, to modify the user interface, add or modify bulletins add community comments, modify assignment rotations, and to specify reports.

As similarly discussed above, the permit workflow system enables clients (e.g., government approving agencies) to review permit details and grant or deny agency approval. Real-time data availability relating to the permit application and of the approval process enables clients to view current filming activity detail, as well as changes, additions and removals relating to the permit application and of potential conflicting permits, giving the clients/approving agencies the ability to make informed decisions regarding each location and film shoot.

Optionally the permit workflow system tracks requests for community notification. For example, certain embodiments enable the permitting agency to create and modify notifications for distribution to the community. By way of illustration, neighbors (e.g., residents and/or businesses within a certain area around or adjacent to the filming location) can request (via a user interface provided as a web page by the workflow system, via a phone call to an person or interactive voice response system, via an email, via a letter, or otherwise), to be notified when filming will take place within a certain distance from the notification requester. The requester can enter in or otherwise specify a notification destination (e.g., an email address, an SMS address, or other address). The workflow system will then accordingly transmit the notification to the community (e.g., those who requested a notification within the community and/or those who are in a specified area relative to the filming location even if they did not request a notification) a predetermined amount of time prior to, and optionally at the time of the filming.

Example embodiments and aspects thereof will now be discussed with reference to the figures.

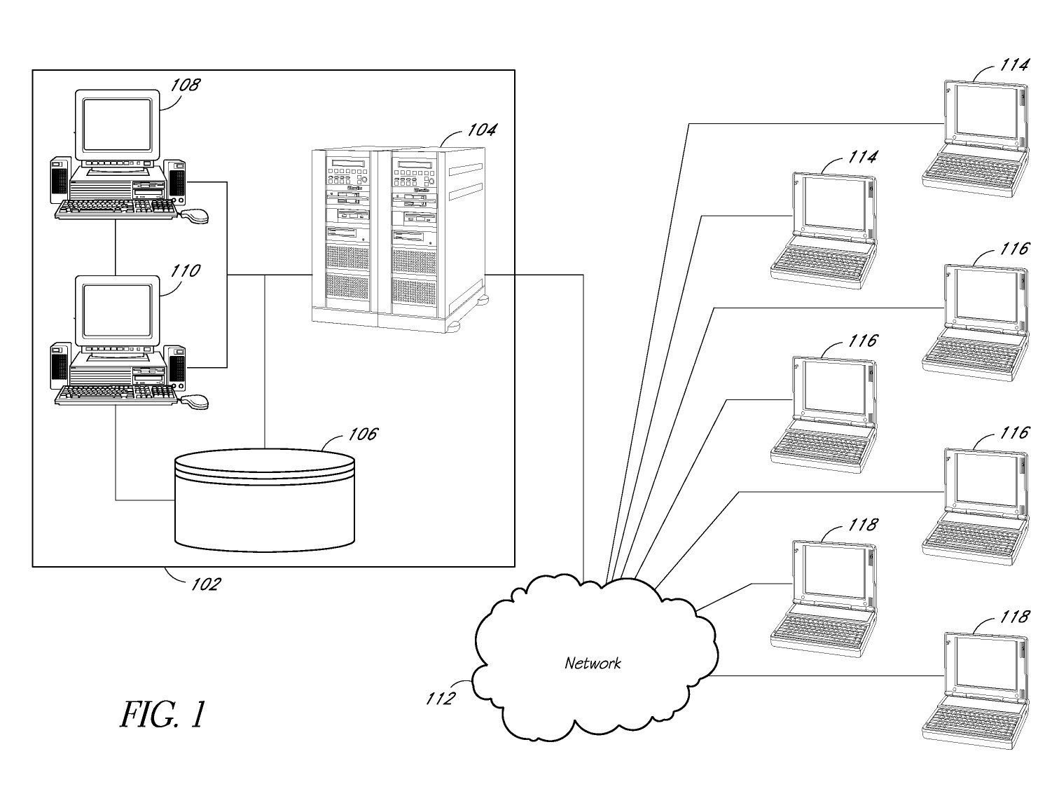

FIG. 1 illustrates an example computing system operating environment. In discussing example embodiments, the term “Website” is used to refer to a user-accessible server site that implements the basic World Wide Web standards for the coding and transmission of hypertextual documents. These standards currently include HTML (the Hypertext Markup Language) and HTTP (the Hypertext Transfer Protocol). It should be understood that the term “site” is not intended to imply a single geographic location, as a Web or other network site can, for example, include multiple geographically-distributed computer systems that are appropriately linked together. Furthermore, while the following description relates to an embodiment utilizing the Internet and related protocols, other networks, such as networked interactive televisions, and other protocols may be used as well.

In addition, unless otherwise indicated, functions described herein are preferably performed by software including executable code/program instructions running on one or more computers. The computers can include one or more central processing units (CPUs) that execute program code and process data, computer readable media, optionally including volatile memory, such as random access memory (RAM) for temporarily storing data and data structures during program execution, non-volatile memory, such as a hard disc drive, optical drive, or FLASH drive (e.g., for storing programs and data, including databases, which may be referred to as a “system database,”) and a network interface for accessing an intranet and/or Internet. In addition, the computers can include a display via which user interfaces, data, and the like can be displayed, and one or more user input devices, such as a keyboard, mouse, pointing device, microphone and/or the like, used to navigate, provide commands, enter information, provide search queries, and/or the like.

However, the system can also be implemented using special purpose computers, terminals, state machines, and/or hardwired electronic circuits. In addition, the example processes described herein do not necessarily have to be performed in the described sequence, and not all states have to be reached or performed. While personal computers or laptops may be referenced herein, other terminal types can be used as well, such as interactive televisions, phones, etc.

The permit workflow system 102 includes a web server 104 and a database 106 (which optionally includes one or more databases). The database 106 can store applicant account information (e.g., name, contact person, address, contact information, etc), applicant permit applications, permit status information (e.g., open, hold, hold for accounting/billing issue, hold for insurance issue, hold for approvals, locked from change, closed, etc.) location information, road conditions, local construction, etc. By way of further example, the stored location information can include addresses, a map grid number, one or more pictures or links to pictures of the location, location specific conditions (e.g., availability of parking, sensitive neighbors, etc.), shooting restrictions, fees (special fees or any fees), an indication as to whether the location is in a fire zone (or other zone which may necessitate special precaution or which may be associated with addition filming restrictions), which council district (or other governmentally defined area) the location is in, police jurisdiction, etc.

The database 106 optionally stores permit fee structures, algorithms for generating fee estimates, approving agency approvals, filming activity, personnel and equipment on location, lane and street closure information, special conditions which affect the specific location and filming activity, etc. Some or all of the foregoing information may optionally be manually entered by an administrator or other entity via a user interface provided for display by the workflow system 102 and/or some or all of the information may be electronically accessed from another data source. As discussed below, some or all of the foregoing information may be used in determining, using the system 102, whether a permit is to be granted.

One or more administrative terminals 108, 110 may be coupled to the web server 104. For example, terminal 108 may be operated by a permitting agency coordinator that coordinates the initial application through the approving agencies until it can be issued to the applicant as a final document. By way of further example, terminal 110 may be operated by a permitting agency operations manager that has a higher level of permissions with respect to the system 102 and permitting process than the coordinator. For example, the operations manager optionally may be provided with the ability to override and approve a wide variety of issues that may arise (e.g., change fees, allow a permit to be issued even if a conflict exists, etc.), that the coordinator cannot. The system 102 may determine the level of permissions a given user has based on user login information (e.g., user ID and/or password), which are used to access from computer readable memory the permissions associated with the user.

The workflow system 102 is connected via a network 112 (e.g., the Internet, an intranet, or other network) to one more applicant terminals 114 (e.g., personal computers, interactive televisions, smart phones, etc.). As described elsewhere herein, the workflow system 102 can transmit templates/permit user interfaces to the applicant terminals 114, and can receive back the applicant entries (e.g., from an applicant location manager). The system 102 can store the entries in the database 106. Optionally in addition or instead, some or all of the permit information can be received via an email, via a fax, or via a hardcopy paper application. The system 102 can then scan the application and/or perform OCR to obtain the permit request data. In addition or instead, an operator can manually enter the data.

The system 102 can further transmit substantially real time permit processing status updates to the applicant (as well as administrators and approving agencies) and can receive applicant specified permit changes via the terminals 114.

The workflow system 102 is optionally further coupled to one or more client systems 116 via the network 108. The client systems 116 may be operated by approvers, which may be government agencies that approve (in whole or in part) the filming activity at requested locations for the specific period of time. The workflow system 102 can serve user interfaces (e.g., via web pages) providing relevant permit detail information, and via which the client can provide their approval.

The workflow system 102 is optionally further coupled to one or more user systems 118 via the network 108, wherein the user systems may be operated by those that have requested notification of filming in their area. The workflow system 102 can track permits (e.g., issued permits), identify users living within a specified geographical area in and around the filming location to whom notification is to be provided, and then transmit such filming notification to the terminals 118 a specified period before and/or during the scheduled filming.

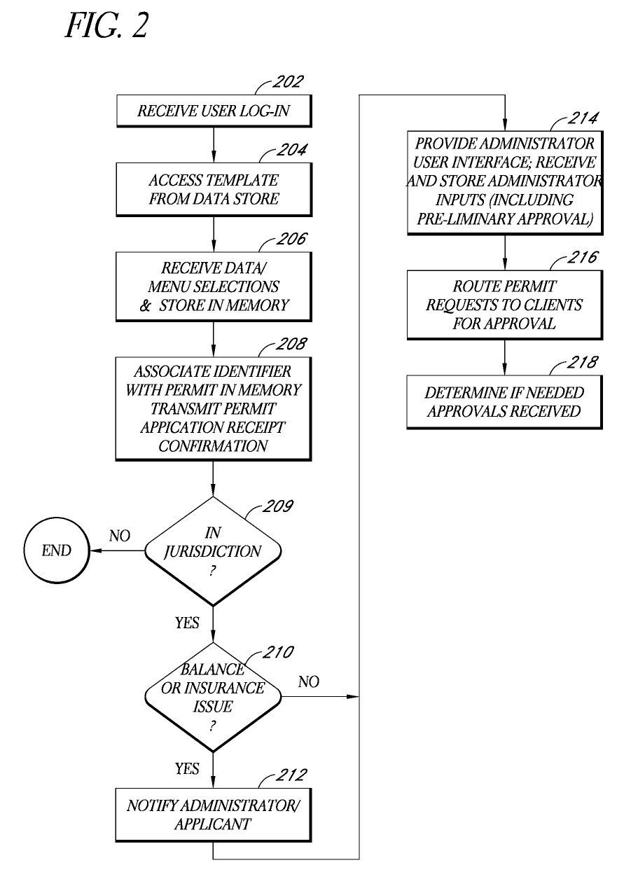

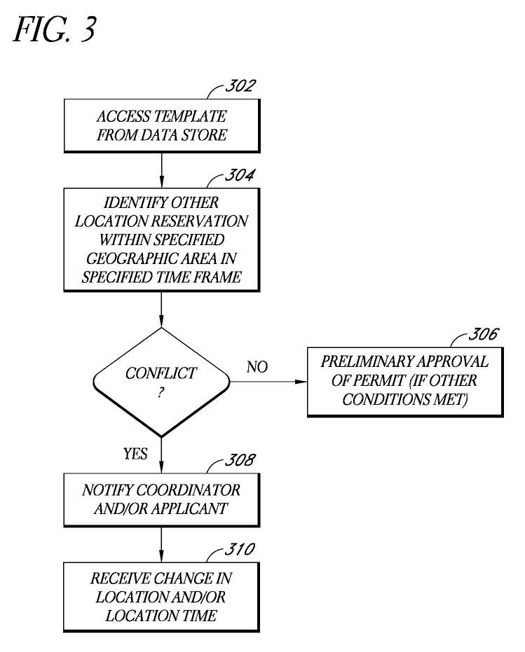

FIG. 2 illustrates an example permit workflow process. At state 202, an applicant logs into the work flow system (e.g., via an applicant terminal coupled to the workflow system via a network). At state 204, the workflow system accesses from a data store a form template previously defined by the applicant, or provides a user interface via which the applicant can define a template). The form template may be used to specify and receive information needed in order for the permit to be submitted.

For example, the template may provide fields via which the applicant can specify general company and contact information. Optionally, the applicant may instruct the system to automatically copy data from a previous permit associated with the applicant. The system will access the previous permit data and copy the data into the new permit. Optionally, only relatively static data is copied, such as general company and contact information, while more dynamic types of data, such as location information and filming activities, will not be copied, and instead, the applicant will be asked to supply such dynamic information. Optionally, the applicant may copy static data from a previous location onto another location. In this case, filming activities, equipment and personnel on location, etc. will be duplicated onto another location or to a copy of the same location. Dynamic data, such as dates and times, will not be copied and need to be manually input. Optionally, a fixed permitting agency-defined form may be used rather then the applicant template.

The form may optionally include a menu (e.g., a drop down menu) of predefined locations which may be selected by the applicant and reserved. For example, the predefined locations may include popular shooting locations, such as landmark buildings, sports facilities, museums, beaches, etc. If the applicant's desired location is not listed on the menu, the applicant can manually enter the address and/or name of the location (e.g., where there is no address, such as for a stretch of beach or intersection) via a location address/identifier field. Optionally, the menu is administratable.

The form may optionally include a menu of predefined filming categories which may be selected by the user. For example, the filming categories may include feature film, made for television movie, documentary, situation comedy, dramatic television show, commercial, music video, still photography, corporate video, etc. Optionally, the menu is administratable.

Optionally, the form includes a menu via which the applicant can specify special shooting conditions for the permit (e.g., gunshots, crashes, pyrotechnics, etc.). If the menu does not include an appropriate shooting condition, the user can enter the shooting condition in a shooting condition field. Optionally, the menu is administratable.

If contact information is not already included in the form, the applicant can manually enter the contact information via contact information fields (e.g., applicant name, contact person, phone number, physical address, email address, etc.). In addition, the applicant can modify information already included in the form.

At state 206, the applicant data/menu selections are received at the workflow system, which stores the data/menu selections in memory. Based on the data entered by the applicant, the workflow system, optionally using artificial intelligence, will provide additional user interfaces, including appropriate data fields for entry by the applicant.

At state 208, the workflow system associates a unique identifier with the permit application (which is stored in memory in association with the permit request), and transmits a confirmation notification (e.g., via email or otherwise) to the applicant, the confirmation optionally including the unique identifier. At state 209, a determination is made as to whether the specified location is out of the permitting agency jurisdiction. If the specified location is out of the permitting agency jurisdiction, a notification is provided to the applicant, and the permit is not issued by the system.

If, at state 210, the workflow system determines (from data accessed from the system database) the applicant has an outstanding balance (e.g., resulting from fees owed relating to previous filming and permits), the applicant is so notified (e.g., via an email or web page), and a hold for billing status is recorded in association with the permit application.

Similarly, the workflow system determines if there are issues with the applicant's insurance information that may prevent issuance of the permit, and if there are, a hold for insurance status is recorded in association with the permit application. For example, the workflow system can determine the applicant's insurance has expired via expiration data information previously entered by the applicant and stored in memory or via expiration information obtained from the insurer or its agent. By way of further example, based on some or all of the following: the applicant's insurance limits, the shooting location, special shooting condition(s), number of trucks, other permit information, etc., the workflow system determines whether the applicant's insurance limits are sufficient.

At state 212, if there is an issue with a past due balance or insurance, the workflow system also notifies a permitting agency administrator to review the issue and, if needed, to work with the applicant to resolve the issue. The administrator optionally can indicate via an administrator user interface that the permit is to be placed on hold (pending resolution of the outstanding issues). Once the issue is resolved (as indicated by the administrator via a status control user interface), the corresponding hold status is removed.

Optionally, the work flow system will examine the current work loads of appropriate administrators and assign such issues to administrators so as to balance the workload substantially evenly across the administrators. The process of balancing the workload evenly, optionally uses artificial intelligence, and optionally takes into account performance and/or experience levels of administrators (as indicated in a data store), so that a very experienced administrator may be assigned a first number of cases in a certain time period, and a less experienced administrator may be assigned a significantly lower number of cases in that same time period. Optionally, permit applications will be assigned on a rotational basis. Optionally, a supervisor or other administrator with the appropriate position can instruct the workflow system to override the rotation and change the rotation.

Optionally, a control is presented via the administrator terminal via which the assigned administrator (e.g., coordinator) can refuse the assignment. Optionally, the system then automatically reassigns the issue to another administrator. Optionally, instead, a supervisor is informed of the refusal and can approve or disapprove the assignment using a corresponding control displayed on the supervisor control. If the supervisor approves the refusal, the system then assigns the issue to another administrator as similarly described with respect to the initial assignment. Optionally, the user interface does not include a control via which the assigned administrator can refuse an assignment.

Optionally, an administrator may have been previously assigned to handle permits associated with a specified title or applicant. If so, the workflow system will read such an indication from a data store, and notify that administrator when an issue arises regarding permits for that title or applicant.

At state 214, a user interface is provided by the workflow system via which the administrator can retrieve from a data store special conditions by permit type and/or location, and via which the administrator can associate the special condition(s) by permit type. In addition, optionally a user interface is provided via which the administrator can enter shooting restrictions to be placed on the permit as they relate to the shooting (where the restrictions will optionally be listed on the issued permit).

In addition, optionally a user interface is provided via which the administrator can add, delete, or modify signoff requirements (by the clients/approving agencies and/or permitting agency personnel/groups). Optionally, a user interface is provided via which the administrator can change fees. Optionally, depending on the level of permissions the administrator has, the administration may only be permitted to alter certain fees (e.g., those payable to the permitting agency), and not others. Optionally, when some or all of the foregoing changes are made, another administrator (e.g., a supervisor) is automatically notified by the system. Optionally, prior to certain or any of the changes going into effect, the supervisor (or other appropriate permissioned person) needs to approve the change (e.g., via a user interface presented by the system), prior to the system applying the changes.

At state 216, once the permit request has been initially approved by the permitting agency, the permit is then routed serially or in parallel to one or more clients (e.g., via email or web pages transmitted to a client terminal, via fax or mailed forms, or otherwise), and a “hold for approvals” status is recorded in association with the permit application. For example, the clients may be governmental and/or non-governmental entities, such as the police department, the fire department, parks department, street maintenance department, or other entity whose approval is needed. The list of entities whose approval is needed may be varied based on the workflow system's analysis of the permit request information or by manual intervention by an administrator. For example, if there are pyrotechnics, fire department approval may be needed. If no special conditions are specified for the filming, then in certain circumstances fire department approval may not be needed.

At state 218, a determination is made as to whether each entity provided permitting approval. Based on the location and filming activities, the permitting workflow system (e.g., operated by a permitting agency) requests approval from the appropriate clients (e.g., approving agencies). The pending request can be transmitted to the client's terminal via a web page notification, an email, an instant message, or otherwise. The client, or approving agency, completes the approval communique, taking into account the specific location and filming activities, then approving, denying or saving the permit request until a later time. During the foregoing process, the permit application is put into a hold status (which is stored by the workflow system). Once all of the needed approval requests have resolution, the corresponding hold status is automatically removed by the workflow system.

At state 220, if the foregoing approvals are obtained, if the applicant insurance is in order, if the applicant does not have an outstanding balance, and if a conflict does not exist, then the permit receives final approval (of course fewer or more conditions may need to be met). The permit is then issued to the applicant. For example, the permit may be electronically emailed and/or downloaded to the applicant terminal (e.g., as a PDF file or other file type), and the applicant can then print out the permit. Optionally, in addition or instead, the permit may be mailed or faxed to the applicant.

During the foregoing process, the applicant, clients, and permitting agency are optionally provided with real-time updates on the processing of the permit. The updates may be provided via a push facility (e.g., via emails, faxes, phone calls, SMS messages, etc.) to the notification recipient, or an interested party (e.g., the applicant, clients, and permitting agency) can access the permit status via a website, such as the permitting agency website.

Certain embodiments provide additional features, including complaint processing. If complaints are received regarding a particular shoot (e.g., via email received at the work flow system, via fax, a letter, a phone call or otherwise), the complaint is stored in workflow memory, the workflow systems determines which coordinator (or other person) is assigned to the shoot/related permit, and the complaint is routed for display to the coordinator assigned to the film permit. The coordinator can categorize the complaint into one or more complaint types, and can enter notes and resolution information into the workflow system. The workflow system can calculate and provide for display complaint volume trending by applicant and/or location, can provide for display daily complain reports, and can provide for display complaint summaries by a combination of variables (e.g., date, location, any types of complaints).

Further, certain embodiments optionally provide GIS (geographic information system) functionality. For example, the workflow system can access addresses/location identifiers from a database (e.g., associated with issued, pending, or closed permits) or entered by a user (e.g., an applicant, administrator or other user) into a form. The system can compare the address/location information to determine if the address/location exists using an internal database and/or an external database (e.g., such as that associated with Google, Microsoft, Yahoo, or other entity). If the address/location does not exist in the database, a notification is automatically provided to the appropriate person (e.g., the applicant and/or an administrator) so that the address/location can be corrected/clarified.

If the address is accurate, the system or a third party accesses global position coordinates associated with the address/location. For example, if the address/location is from a permit application, a map may be provided for display to the applicant and/or administrator including the address/location. The map may include the actual location (e.g., highlighted with a visual pin, border, or other highlighting technique) and the surrounding area. The map may include an actual photograph (e.g., an aerial, space, and/or street view photograph) of the location and surrounding area, a graphic map showing streets and addresses, or a hybrid map, wherein a photograph of the location and surrounding area is overlaid with map graphics map showing streets and addresses.

Optionally, the map will further display the locations (e.g., highlighted with a visual pin, border, or other highlighting technique) of other locations already reserved within a specified area and a specified time frame relative to the location and the date/time of that requested in the permit application. The map and/or adjacent text will optionally identify conflicts (e.g., using a color coding, icon, a border, permit numbers, and/or other technique to indicate which reservations are in conflict).

Optionally, the map will also indicate (e.g., by highlighting with a visual pin, border, or other highlighting technique), if a special shooting condition exists at a location. If example, if a location is in a fire hazard zone, a border may be displayed around the zone. Similarly, if the location is in a certain district, a border may be displayed around the district.

The map may also indicate one-way streets, parking availability, road work, road closures, accidents, and/or other items of interest.

FIG. 3 illustrates an example conflict identification and resolution process. The process can be used to determine if a requested filming time and location are sufficiently close to another filming event time and location to potentially cause a problem (e.g., as there may be too many trucks or street closures, which are likely to cause an unacceptable amount of traffic disruption, parking problems, and/or other problems).

At state 302, the workflow system receives a permit request, including a time and location, and optionally the types of information as discussed above (e.g., the number of trucks and other support equipment and vehicles that will be used, whether street closures will be needed, etc.). At state 304, the system accesses a data store, such as the database discussed above, and identifies if other location requests and/or approved permits exists for locations within a specified distance or within a specified area of the requested location, where the shooting is to take place at the same time or within a specified period of time as the requested time. The specified area and time period may be selected so that if the requesting time and location is within the specified area and time period, the system will indicate a conflict exits. At state 306, if no conflict exists, the permit is preliminarily approved (subject to client approval and/or other conditions).

If a conflict exists, then at state 308, the coordinator assigned to the permit is automatically informed (e.g., via email, a web page, or otherwise) substantially immediately, and the permit is placed on hold (optionally where a “conflict hold” status is stored in memory in association with the permit application). Optionally, the applicant is also informed. Optionally, the communication presents a map to the applicant and/or the coordinator indicating where the competing filming event is taking place and the filming hours.

At state 310, if the applicant modifies the requested location and/or filming time, the process then process back to state 302.

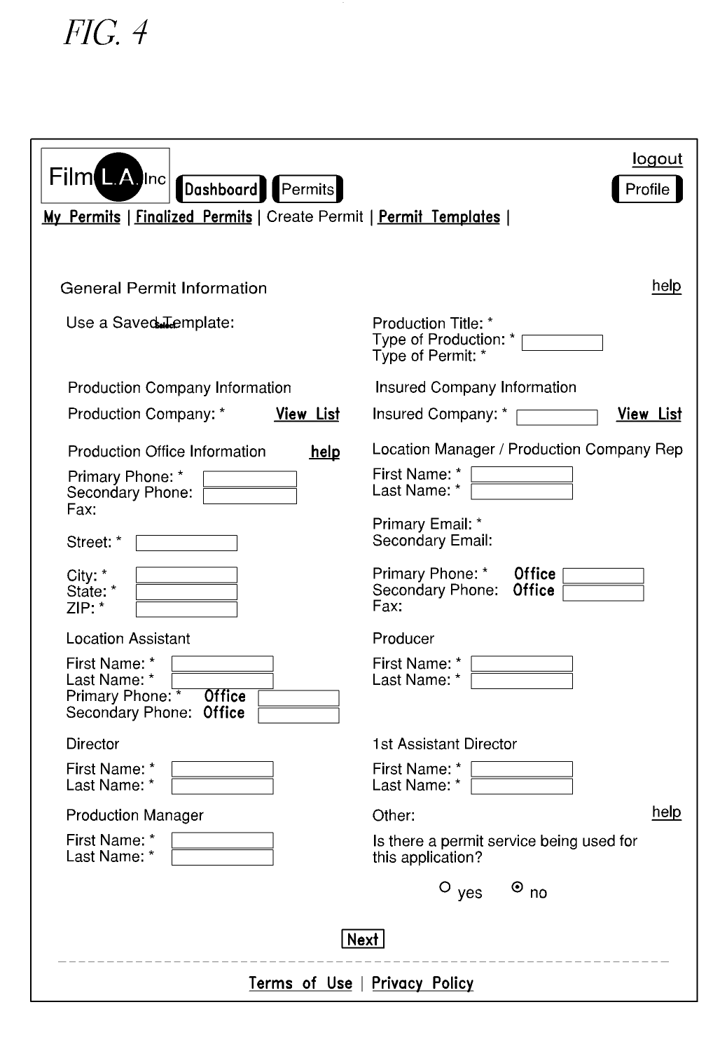

FIG. 4 illustrates an example permit application user interface. In this example, fields are provided for receiving the following information:

The production title, the type of production (e.g., TV reality, feature film, sitcom, documentary, etc.), the type of permit (e.g., filming, still, etc.), production company information including the production company name and their contact information, the insured company name (which may be the same as the production company name), names associated with the producer, the director, the first assistant director, the production manager, the location manager and associated contact information, the location assistant and associated contact information, and the number of locations associated with the requested permit. Additional, fewer, and different fields can be used.

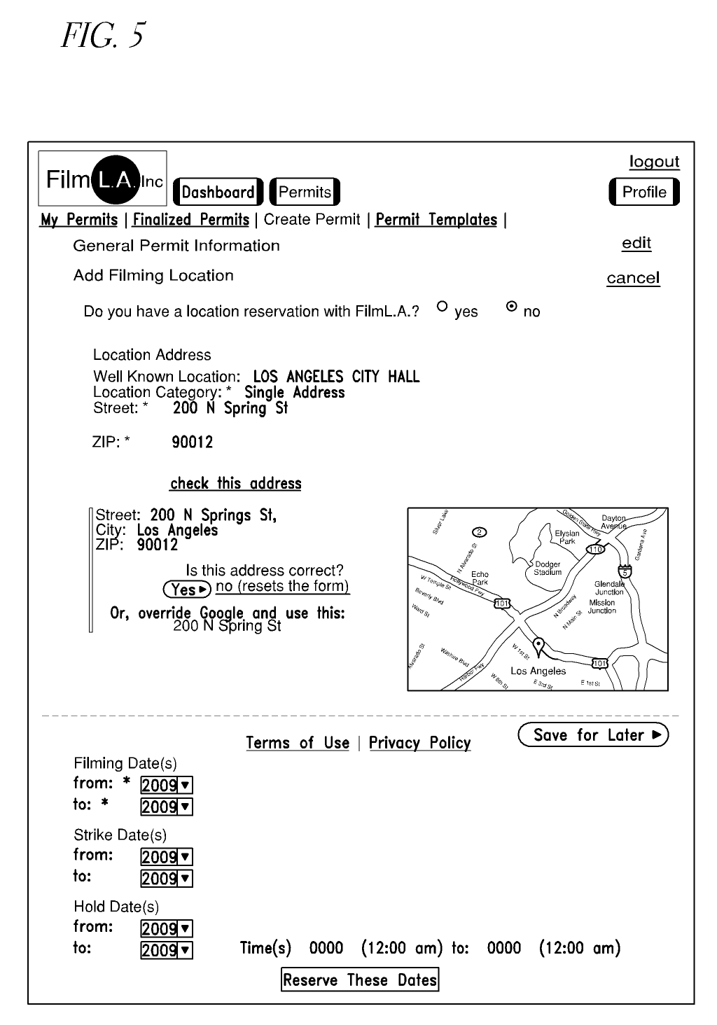

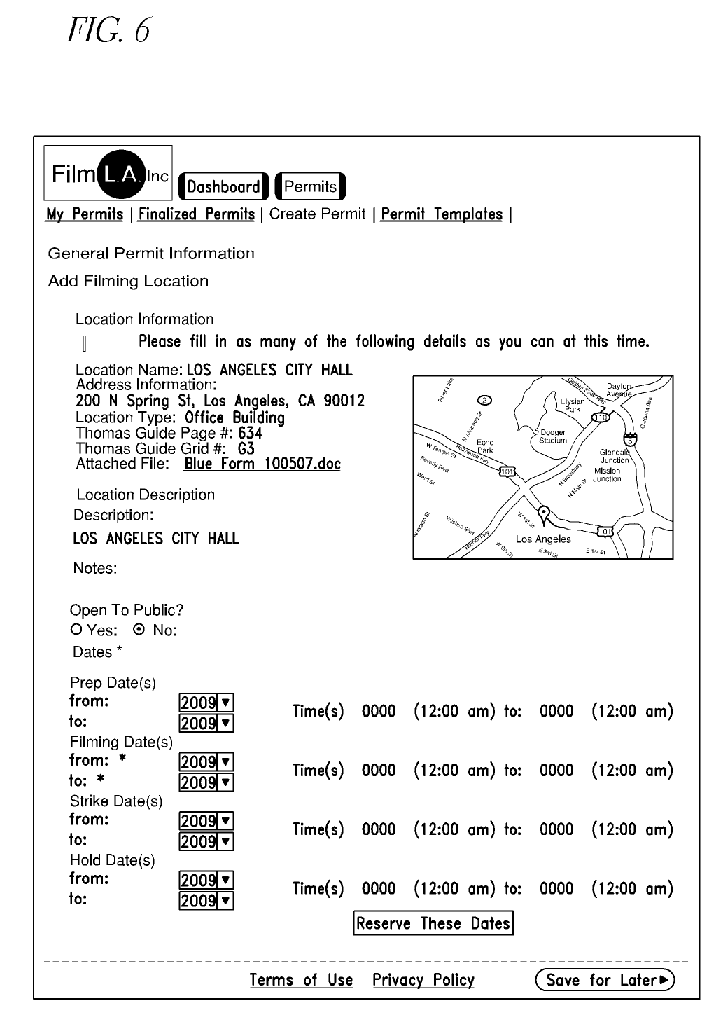

FIG. 5 illustrates an example location selection user interface. The user can select a location via a menu listing popular locations or by entering an address. If the user selects a location from the menu, then the address information, location type, and map data fields are prepopulated using data accessed from the database. In addition, the user interface displays a map corresponding to the address and the surrounding area, with a flag at the specific location. The user interface also prompts the user to confirm that the presented address is correct via a confirmation control (e.g., a “yes” control, a “no” control). If the address is not correct, the user can activate the “no” control, and the address is cleared from the address field. The user can then reenter the address with the correct address.

FIG. 6 illustrates an example location reservation user interface. In addition to displaying information displayed via the location selection user interface, a control is provided via which the user can indicate whether the location is to be opened to the public during filming or not. The user can add notes in a “notes” field, and specify dates and times for which the user wants to reserve the location for preparation and filming, as well as strike and hold dates and times.

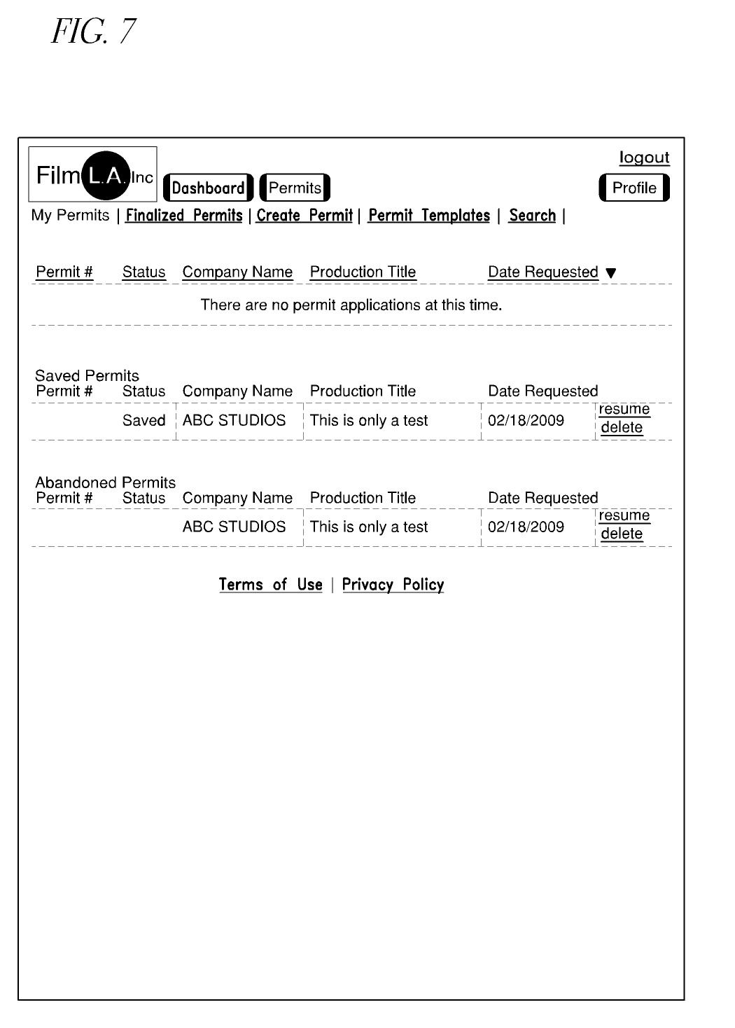

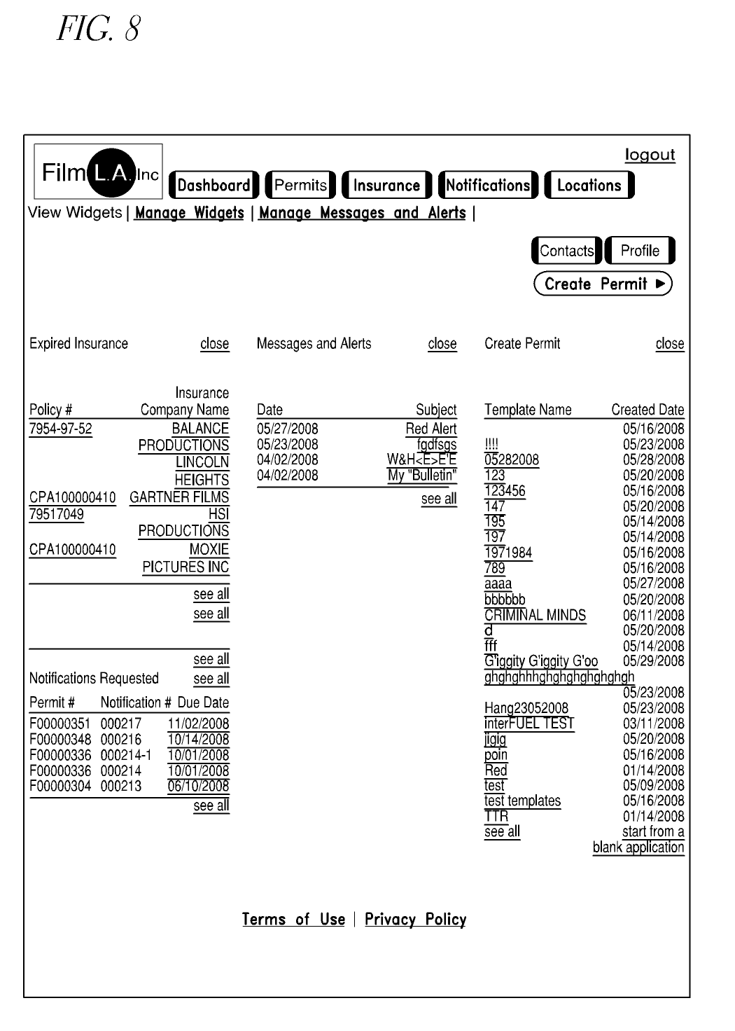

FIG. 7 illustrates a permit status interface listing the user's permits (whether unfilled, pending, issued or expired), the permit number, the permit status, the production company name, the production title, and the date the permit was requested.

FIG. 8 illustrates an example administrator user interface, which, for example, can be utilized by a coordinator. Optionally, the system inhibits access to administrator user interfaces with respect to applicants and external approving agencies. The user interface lists insurance policies that have expired, including the policy number and the insured company name. The user interface also lists the permits assigned to the coordinator accessing the user interface, including the application date, the date of first activity, and the project title. A section lists the permits associated with notification requests (e.g., by residents/business in the area of the filming location), including the permit number, notification number, and the due date. A messages and alerts section lists message/alert dates and subject. A section lists the permits that are pending manager approval, including the permit number and project title. A create permit section lists template names and template creation dates. A new registration section lists the corresponding names and registration dates. The user interface lists permit assignments, including the name of the coordinators and the number of permits assigned to the coordinators. The operations manager user interface optionally provides similar information and controls.

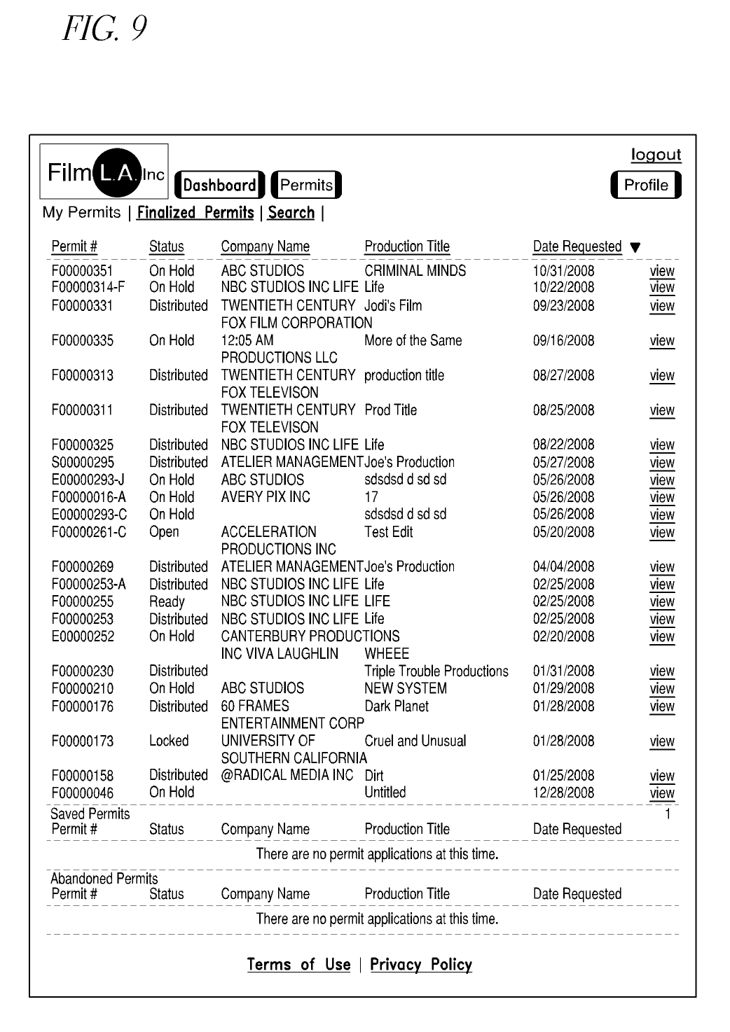

FIG. 9 illustrates an example approver user interface. The user interface lists permits waiting approval by the approver. The user interface lists the permits, including the associated permit numbers, company name, production title, and date requested. A view control, when activated, causes the corresponding permit application to be presented. A saved permit section lists saved permits. An abandoned permit section lists abandoned permit.

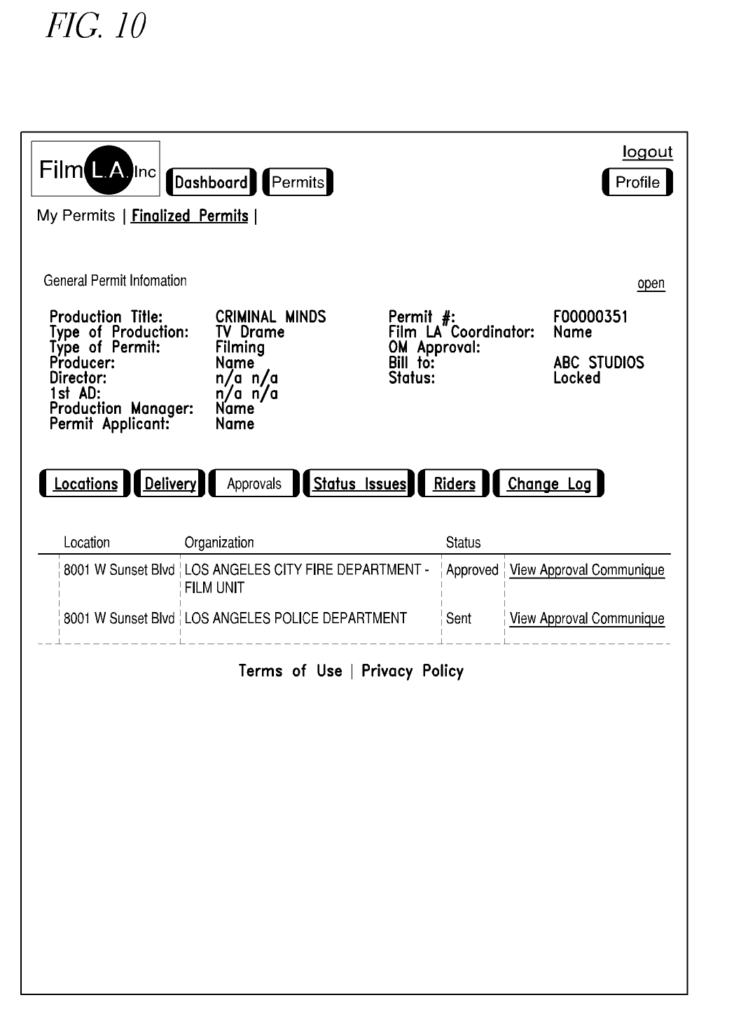

FIG. 10 illustrates an approver user interface providing detailed status information. The user interface lists general permit information and in addition, lists the organizations whose approval is need, and the status of the approval (e.g., sent, approved, rejected, etc.). A link is provided in association with each list approver, that when activated, causes the approval communique to be presented.

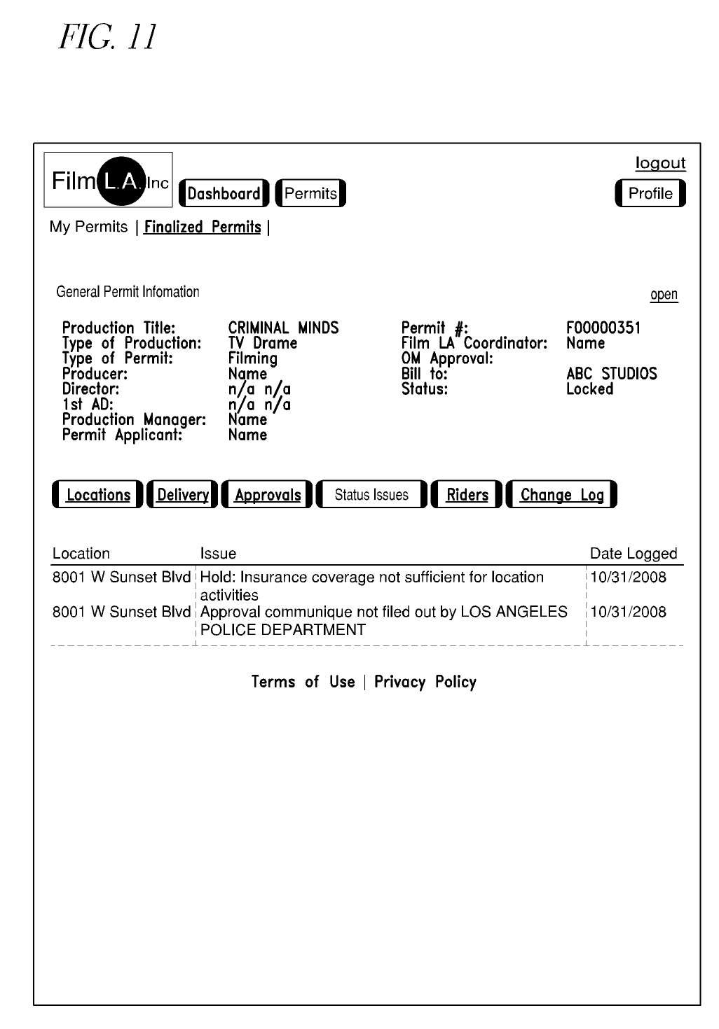

FIG. 11 illustrates an approver user interface providing detailed status information. The user interface lists general permit information and in addition, lists the status issues which are inhibiting issuance of the permit, and the date the corresponding issue was logged.

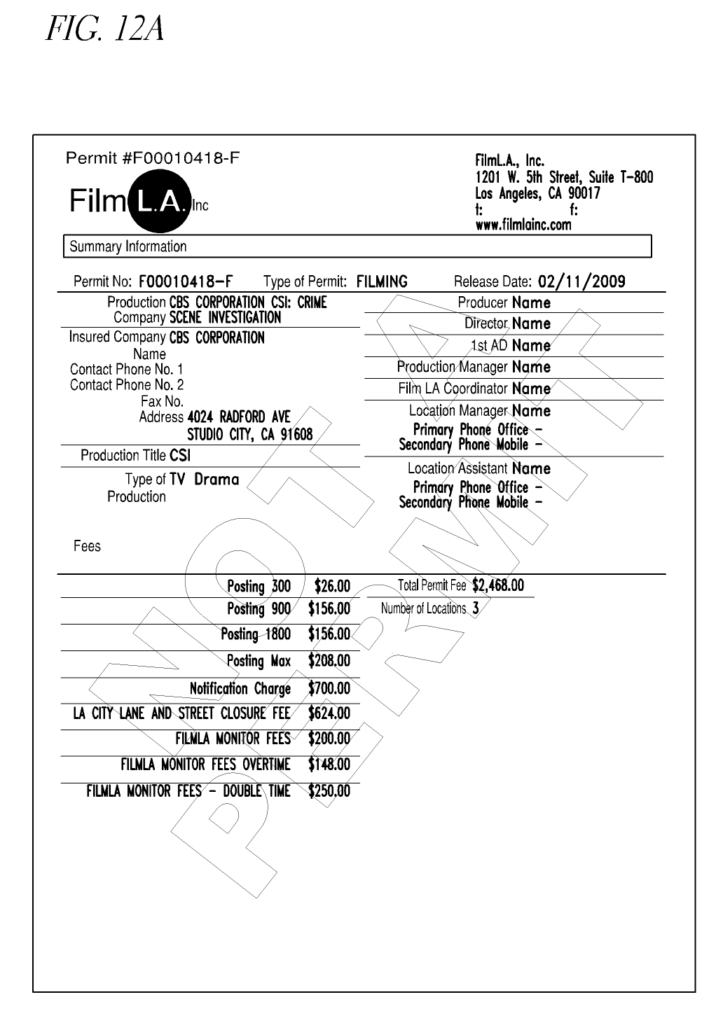

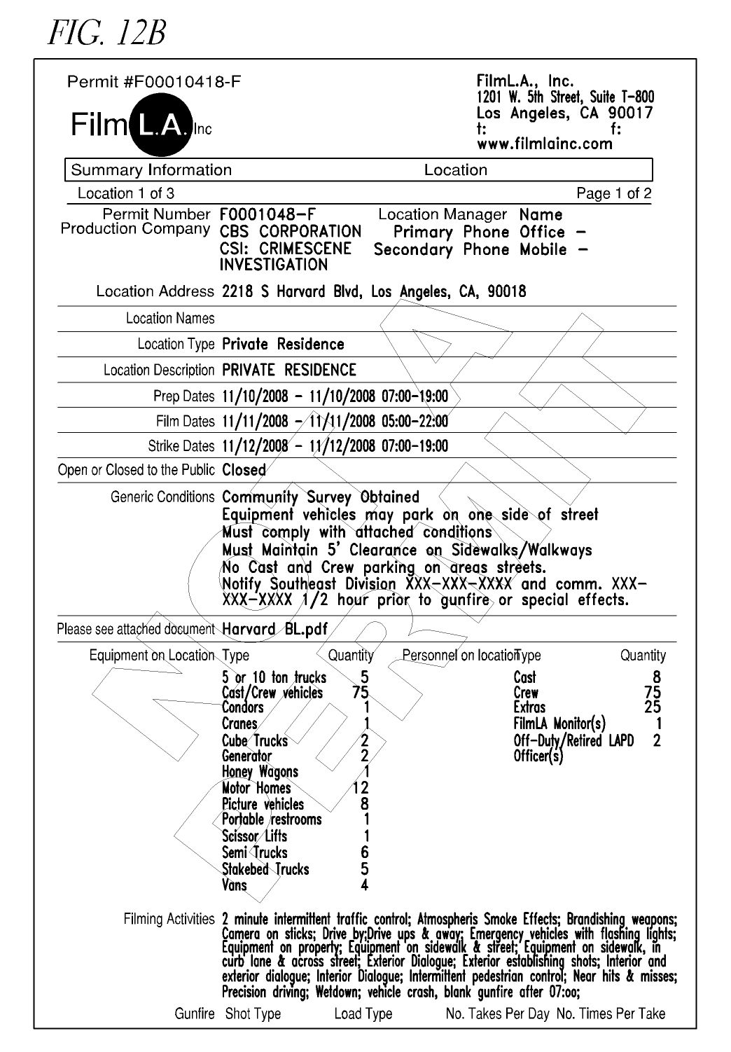

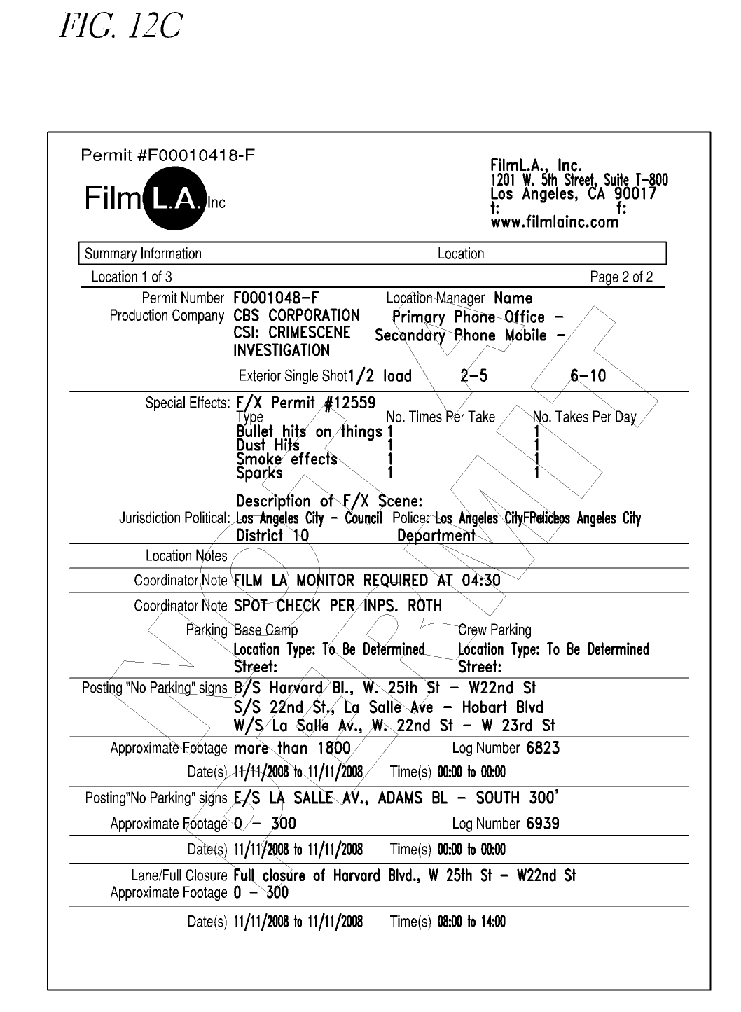

FIGS. 12A-C illustrate an example permit (this example is marked “not a permit” to indicate that it has not yet received final approval). Not all data fields need to contain data. Optionally, fewer or additional fields may be used. Some of the data may be provided by the applicant via the permit work flow system (e.g., using a paper or electronic form, or verbally), and some data may be generated by the workflow system (e.g., the permit number) and/or may be entered by an administrator.

The example permit lists a uniquely assigned permit number, the permit type (e.g., filming), the release date, the production company name, the insured company name (which may be the same as the production company name), the insured company name contact information, the production title, the type of production (e.g., TV reality, feature film, sitcom, documentary, etc.), the fees (e.g., the permitting agency rider fee, posting fees, notification fees, street closure fees, filming agency monitoring fees, other fees, and the total fees), the producer, the director, the first assistant director, the production manager, the permitting agency coordinator, the location manager and associated contact information, the location assistant and associated contact information, and the number of locations associated with the permit.

In addition, the example permit includes location information, such as location address, location name, location type (e.g., private residence, public park, beach, commercial building, etc.), location information, and an indication as to whether or not the filming location is open or closed to the public. The permit also lists generic conditions related to the location and/or film category (e.g., were vehicles may or may not be parked, sidewalk clearness area, notification requirements, etc.).

Still further, the permit may list equipment on location (e.g., trucks, cast/crew vehicles, cranes, generators, motor homes, portable restrooms, vans). Still further, the permit may list personnel on location (cast, crew, spot check, etc.).

The permit may provide a summary of the filming activities (e.g., equipment on sidewalk only, interior/exterior filming, etc.). In addition, the permit may list the political jurisdiction (e.g., city, district, etc.), the police department that has jurisdiction over the filming/location, and the fire department that has jurisdiction over the filming/location.

Additionally, the permit may include location notes, such as identifying parking areas for the base camp and the crew.

Methods and processes described above may be embodied in, and fully automated via, software code modules executed by one or more general purpose computers or processors. The code modules may be stored in any type of computer-readable medium or other computer storage device. Some or all of the methods may alternatively be embodied in specialized computer hardware. Further, components and tasks described herein can be implemented as web services. Communications (e.g., notifications) discussed above can be performed using one or more of the following techniques and/or other techniques: email, web page, instant message, short messaging service (SMS) message, fax, hard copy correspondence, phone, or otherwise.

In addition, conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Although this disclosure has been described in terms of certain example embodiments and applications, other embodiments and applications that are apparent to those of ordinary skill in the art, including embodiments and applications that do not provide all of the benefits described herein, are also within the scope of this disclosure. The scope of the inventions is defined only by the claims, which are intended to be construed without reference to any definitions that may be explicitly or implicitly included in any incorporated-by-reference materials.

What is claimed is:

1. A computer-implemented method for managing workflow, the method comprising:
receiving at a first computer system, the first computer system including one or more processors, a filming permit request from a requester, the request including insurance policy information and a filming location reservation request, wherein the filming location reservation request specifies a first location, a date, and a time period;
examining, using the first computer system, workloads of a plurality of coordinators;
at least partly based on the workload examination, assigning the permit request to a first coordinator so as to enhance workload balance;
determining, using the first computer system, if the insurance policy associated with the insurance policy information has a deficiency, wherein the deficiency relates to expiration of the insurance policy and/or to insufficient policy limits;
determining, using the first computer system, whether a conflict exists with respect to the filming location reservation request by determining whether another filming location reservation request exists within a first area during a first time period, wherein the first area includes an area surrounding at least a portion of the first location;
automatically transmitting a notification to the requester and to the first coordinator if there is an insurance policy deficiency and/or a location conflict, wherein the notification provides an indication to the first coordinator that the one or more permit request issues need to be resolved;
routing via a network the filming permit request to one or more approving entities associated with the workflow whose tasks include approving or disapproving the permit request;
receiving at the first computer system an approval or a disapproval of the filming permit request from the one or more approving entities associated with the workflow;
providing, via the first computer system substantially, real-time status information regarding permit request approval updates from the one or more approving entities to the first coordinator and to the requester;
determining if the one or more approving entities have provided approval indications; and
based at lest in part on:
the determination as to whether one or more approving entities have provided approval indications;
the determination as to whether the insurance policy has a deficiency; and/or
the conflict determination;
indicating whether an approved film permit is to be issued to the requester.

2. The method of claim 1, further comprising determining which coordinator to assign the filming permit request to based in part on performance and/or experience level indicators associated with the coordinators accessed from a data store.

3. The method of claim 1, further comprising:
enabling the first coordinator to provide a reassignment request with respect to the permit request; and
routing the reassignment request to an individual for approval.

4. The method of claim 1, further comprising issuing an approved film permit to the requester at least partly in response to determining that the insurance policy is not deficient, that each of the one or more approving entities have provided corresponding approval indications, and on determining that a location conflict does not exist with respect to the permit request, and
transmitting the approved film permit to a terminal associated with the requester.

5. The method of claim 1, further comprising:
transmitting over the network a permit application user interface to a terminal associated with the requester, the user interface including fields to receive information including: production type, permit type, production company information, insured company name, the location manager and/or location assistant contact information;
receiving at the first computer system data entered by the requester into the fields; and
generating a permit based at least in part of the received data.

6. The method of claim 1, further comprising:
at least partly in response to the location reservation request, providing for display to the requester an map including the requested filming location and a surrounding area; and
visually emphasizing the requested filming location.

7. The method of claim 1, further comprising:
automatically estimating, via the first computer system, a permit-related fee based at least in part on information included in the filming permit request and on historical data for filming events having one or more similar characteristics to that associated with the permit request; and
providing the fee estimate for display.

8. A computer-readable storage media containing instructions that, when executed are configured to:
examine data associated with a filming permit request, the permit request including a reservation request for filming at a first location, on a first date, at a first time period;
examine workloads associated with a plurality of film permit coordinators;
access indicators as to performance and/or experience associated with the film permit coordinator;
based at least in part on the workload examination and the performance and/or experience indicators, assign the workflow permit to a first permit coordinator;
automatically identify one or more deficiencies related to the permit request to the first permit coordinator;
determine whether a conflict exists with respect to the filming location reservation request by determining whether another filming location reservation request exists within a first area during a first time period, wherein the first area includes an area surrounding at least a portion of the first location;
route the permit request to one or more approval entities;
record approvals from the one or more approval entities in computer readable memory;
provide approval status to the first permit coordinator;
based at least in part on:
the determination as to whether one or more approving entities have provided approval indications;
the determination as to whether the permit request has a deficiency; and/or
the conflict determination;
provide an indication related to whether an approved film permit is to be issued to the requester.

9. The computer-readable storage media of claim 8, wherein the instructions are further configured to provide a user interface via which the first permit coordinator can provide a reassignment request with respect to the permit request and route the reassignment request to an individual for approval.

10. The computer-readable storage media of claim 8, wherein the instructions are further configured to determine if an insurance policy associated with the permit request has expired, and if so, transmit a notification to the requester and/or the first permit coordinator regarding the policy expiration.

11. The computer-readable storage media of claim 8, wherein the instructions are further configured to transmit over a network to a terminal associated with the requester an approved film permit.

12. The computer-readable storage media of claim 8, wherein the instructions are further configured to:
transmit over the network a permit application user interface to a terminal associated with the requester, the user interface including fields to receive information including: production type, permit type, production company information, insured company name, the location manager and/or location assistant contact information;
receive at the first computer system data entered by the requester into the fields; and
generate a permit using at least a portion of the received data.

13. The computer-readable storage media of claim 8, wherein the instructions are further configured to provide for display to the requester an map including the requested filming location and a surrounding area, wherein the requested filming location is visually emphasized.

14. The computer-readable storage media of claim 8, wherein the instructions are further configured to estimate a permit-related fee based at least in part on information included in the permit request and on historical data for filming events having one or more similar characteristics to that associated with the permit request and to provide the fee estimate for display.

15. A computer-implemented method for managing workflow, the method comprising:
receiving at a first computer system, the first computer system including one or more processors, a filming permit request from a requester, the request including a filming location reservation request, wherein the filming location reservation request specifies a first location, a date, and a time period;
examining, using the first computer system, workloads of a plurality of coordinators;
at least partly based on the workload examination, assigning the permit request to a first coordinator;
determining, using the first computer system, whether a conflict exists with respect to the filming location reservation request by determining whether another filming location reservation request exists within a first area during a first time period, wherein the first area includes an area adjacent to at least a portion of the first location;
automatically transmitting a notification to the requester and/or to the first coordinator if there is a location conflict;
routing via a network the filming permit request to one or more approving entities associated with the workflow whose tasks include approving or disapproving the permit request;
receiving at the first computer system an approval or a disapproval of the filming permit request from the one or more approving entities associated with the workflow;
providing, via the first computer system, substantially real-time status information regarding permit request approval updates from the one or more approving entities to the first coordinator and to the requester;
determining if the one or more approving entities have provided approval indications; and
providing an indication related to whether an approved film permit is to be issued to the requester.

16. The method of claim 15, further comprising determining which coordinator to assign the filming permit request to based in part on performance and/or experience level indicators associated with the coordinators accessed from a data store.

17. The method of claim 15, further comprising determining via the first computer system whether an insurance policy is associated with the permit request is deficient, and if so, transmitting a notification to the first permit coordinator.

18. The method of claim 15, further comprising transmitting the approved film permit to a terminal associated with the requester.

19. The method of claim 15, further comprising:
at least partly in response to the location reservation request, providing for display to the requester a map including the requested filming location and a surrounding area; and
visually emphasizing the requested filming location.

20. The method of claim 15, further comprising:
automatically estimating, via the first computer system, a permit-related fee based at least in part on information included in the filming permit request and on historical data for filming events having one or more similar characteristics to that associated with the permit request; and
providing the estimated fee for display.
